(19) United States
(12) Patent Application Publication
(10) Pub. No.: US 2004/0017831 A1
(43) Pub. Date: Jan. 29, 2004

(54) System and method for processing SI data from multiple input transport streams

(76) Inventors: Jian Shen, Princeton, NJ (US); Nagaraj Nandhakumar, Pennington, NJ (US); Mark Corl, Princeton Junction, NJ (US); Glen Myers, Hoboken, NJ (US)

Correspondence Address: BIRCH STEWART KOLASCH & BIRCH, PO BOX 747, FALLS CHURCH, VA, 22040-0747, US

(21) Appl. No.: 10/407,229

(22) Filed: Apr. 7, 2003

Related U.S. Application Data
(60) Provisional application No. 60/369,865, filed on Apr. 5, 2002.

(51) Int. Cl. H04J 1/00

(52) U.S. Cl. 370/486; 370/537

(57) ABSTRACT

A system and method for processing SI data such as PSIP/PSI data in a digital TV environment are discussed. In the method for processing SI data from a plurality of input transport streams into at least one output transport stream for a digital broadcasting, SI data from the input transport streams are extracted and decoded, the decoded SI data are mapped by being reconfigured for the output transport stream, and the mapped SI data are merged and re-encoded to generate the output transport stream.

The present application claims the priority benefit of U.S. Provisional Application No. 60/369,865 filed Apr. 5, 2002, the entire contents of which are herein fully incorporated by reference.

### BACKGROUND OF THE INVENTION

1. Field of the Invention

The present invention is related to a system and method for processing service information (SI) data and, more particularly, to a system, method and computer program for processing Program and System Information Protocol (PSIP)/program specific information (PSI) data from multiple input transport streams in a digital broadcast environment.

2. Discussion of Background Art

In digital television (DTV) broadcast, video, audio and data such as SI data can be carried over the air (also referred to herein as “terrestrial broadcast”) or on cable in a cable system (also referred to herein as “cable broadcast”). Generally, in these DTV broadcasts, an MPEG-2-compliant transport stream (TS) can simultaneously carry multiple video, audio, and/or data programs.

In Advanced Television Standards Committee (ATSC)-compliant broadcasting which is generally terrestrial broadcast, metadata describing the contents of the transport stream are carried by PSIP. The PSIP data include collections of tables which are encapsulated into MPEG-2 compliant TS packets. These packets have unique packet identification (PID) values that can be used to distinguish the PSIP tables from each other, as well as from the audio, video, and data streams.

The PSIP tables are defined in ATSC standard A/65A and mainly include the following as shown in Table 1:

TABLE 1
Terrestrial PSIP Tables

| Table | Description |
|---|---|
| Master | gives PIDs, table Ids, sizes, and |
| Guide | version numbers for all other PSIP |
| Table | tables. |
| (MGT) | |
| System | gives current UTC time, convertible to |
| Time Table | wall clock time at receiver. |
| (STT) | |
| Rating | describes system(s) for rating |
| Region | broadcast content, referenced by |
| Table | “content advisory descriptors” in EITs |
| (RRT) | (not sent when RRT is fixed, as in |
| | U.S.). |
| Virtual | provides details about the Virtual |
| Channel | Channels in the stream, including |
| Table | channel name and number (slightly |
| (VCT) | different forms for terrestrial and cable |
| | PSIP). |
| Event | describe upcoming program “events.” |
| Information | including title, time, captioning |
| Tables | services, rating information. There |
| (EITs) | may be up to 128 EITs, each |
| | containing information for events in a |
| | 3-hour period, thus covering up to 384 |
| | hours, or 16 days, into the future. |
| Extended | give extended descriptions of Virtual |
| Text | Channels and events. There mey be |
| Tables | one channel ETT and up ro 128 event |
| (ETTs) | Etts, plus up to 128 data event |
| | ETTs. |
| Data Event | describe upcoming data “events,” |
| Tables | including title, time, and other |
| (DETs) | information about the data service. |
| | There may be up to 128 DETs, each |
| | containing information for data events |
| | in a 3-hour period. |
| Directed | provides definitions of virutal channel |
| Channel | change requests. |
| Change | |
| Table | |
| (DCCT) | |
| DCC | carries code values & selection criteria |
| Selection | names for reference from DCCT. |
| Code | |
| Table | |
| (DCCSCT) | |

The architecture of the PSIP tables in Table 1 is also shown in FIG. 1. All these tables and their functions and operations are known.

The PSIP tables enable a number of valuable features for DTV receivers, including:

Tuning to programs by virtual channel numbers, rather than physical broadcast frequency bands;

Selecting language tracks;

Creating interactive electronic program guides;

Applying “V-chip” restrictions on viewing based on content advisory ratings.

In addition to the PSIP tables, the MPEG-2-compliant TS includes several additional tables (SI data) defined in the MPEG-2 standards for carrying program specific information (PSI). The program association table (PAT) and program map table (PMT) are among these tables. These additional tables and their functions and operations are also known.

The PSIP standards identify virtual channels (VCs) within an MPEG-2 compliant TS by the combination of “major channel number” (mandated to be equal to the analog channel number for stations with existing NTSC licenses) and “minor channel number.” The virtual channel numbers allow DTV receivers to tune the DTV signal using the same analog channel number, even though the physical channel is at a different frequency. In addition, PSIP data provide details about alternative language tracks, content advisory ratings, and audio and video streams (elementary streams) within the broadcast TS. PSIP data also support interactive electronic program guides (EPGs) in standard, off-the-shelf TV sets and set-top boxes (STBs) by supplying information on upcoming programs. The terrestrial broadcast (ATSC) standards and mechanisms described thus far allow the user to purchase a standard DTV receiver, hook it up to an antenna, turn it on, and have it work over the air with a minimum manual configuration.

On the other hand, in a cable environment, the service information is generally carried in two forms—in-band PSIP and out-of-band (OOB) SI. The in-band PSIP carriage is useful for the off-the-shelf cable-ready DTV receivers, while the OOB SI carriage typically needs a Point of Deployment security (POD) module to access. The cable in-band PSIP carriage differs in some subtle but significant ways from the terrestrial PSIP carriage described above. Cable metadata relies much more on information in the PMT. For example, both the caption service descriptor and the content advisory descriptor (when present) generally must be carried in the EITs and may optionally be included in the PMT in the terrestrial broadcast. For cable, these descriptors (when present) must be located in the PMT, and may be carried in the EITs. Additionally, in cable the AC-3 audio descriptor is found in the PMT, and so is optional in the cable EITs.

Another difference between the terrestrial broadcast and cable broadcast is in the VCT. The VCT generally comes in two forms, one for terrestrial broadcasts (the TVCT) and one for cable broadcasts (the CVCT). They are mostly similar with a few differences. Both list the virtual channels that appear in the broadcast stream and give information for each one including: Channel name, Channel number (two-part for TVCT, one- or two-part for CVCT), MPEG-2 program number (used by receivers to coordinate with entry in PAT), Service type (video, audio, or data-only), and Source_id (used to coordinate VCs with EIT entries).

The OOB SI is defined in SCTE standard SCTE 65. While similar in nature to in-band PSIP, the SCTE 65 tables are optimized for the cable environment where tuning relies much more heavily on the data in the PMT. Also, aggregate EITs (AEITs) and ETTs (AETTs) are used to reduce the number of PID values that the POD host will need to process (MGT table types and corresponding tag values associate and distinguish the various table sections, rather than multiple PID values).

Other differences between the terrestrial broadcast and cable broadcast include, but are not limited to:

The SI base PID value is 0×1FFC (in contrast to 0×1FFB for ATSC PSIP).

The Network Information Table (PID 0×1FFC) delivers the Carrier Definition Subtable (CDS) and the Modulation Mode Subtable (MMS). CDSs define the number of carriers used in the system and their frequency locations. MMSs define the modulation format (e.g. QPSK or 64QAM) for each carrier in the system.

Two alternative types of Virtual Channel Table, Short-form (S-VCT) and Long-form (L-VCT), may be present in the cable transport stream, depending on selected profile.

The Network Text Table (PID 0×1FFC) carries Source Name Subtables to associate names with each service listed in an S-VCT.

The S-VCT and L-VCT deliver the Virtual Channel Map, Defined Channels Map, and Inverse Channel Map—the keys to channel navigation using the OOB metadata. VCTs also identify the physical cable carrying the transport stream. The L-VCT also includes carrier frequency and modulation mode information.

Up to 30 days of event information may be carried in AEITs and AETTs. These use a maximum of four PIDs.

Multiple MGTs corresponding to distinct channel maps may be included in the transport stream, distinguishable within the POD module (the POD identifies the “correct” MGT using the included map_id value and discards the others).

Terrestrial DTV channels have fixed bandwidth of approximately 19.39 Mbps, but digital cable systems use modulation methods that allow carriage of 27 Mbps or even 38.8 Mbps per transport stream.

When the DTV signal is carried on cable to the consumers in the cable system, the PSIP information needs to be preserved in order for the consumers to retain the ability to tune to the signal using a cable-ready DTV receiver, analogous to using an antenna.

Because digital cable systems use modulation methods that allow carriage of higher bandwidth transport streams, cable providers would want to re-multiplex multiple programs from different DTV sources (e.g., terrestrial receivers, satellite receivers, etc.) into a single cable stream. In addition, cable providers may want to select which programs (or VCs) from a given transport stream to carry. In order to optimize the usage of cable bandwidth, the cable providers would desire to combine programs from several terrestrial transport streams together in one multiplex. To accomplish this, the PSIP data from different input transport streams must be merged and reconciled for a new output transport stream. However, the traditional MPEG-2 multiplexers at head-end systems are not equipped to and do not know how to handle this process of merging PSIP data from independent transport streams.

Absent such capability to merge PSIP data in the traditional MEPG-2 multiplexers, the tradition MEPG-2 multiplexers in existing head-end systems process the PSIP data in a “block” mode or in a “pass” mode. In the block mode, the MPEG-2 multiplexers block and ignore all PSIP data according to MEPG-2 standards. This results in the loss of important SI data such as PSIP/PSI data at the head-end. On the other hand, in the pass mode, the MPEG-2 multiplexers pass the PSIP data without any modifications thereto. But, if multiple input transport streams are involved, then the sets of data from the TSs will have the same PID value and multiple versions of the same table type may exist in the TS at the same time. Since the receivers at the broadcast receiving side do not know how to handle such duplicate data, it results in the loss of SI data at the receiving side and causes failures or crashing of the receivers at the receiving side.

Thus, a new service information (SI) processing system is needed that can effectively process the PSIP data from multiple input transport streams by merging and generate one or more output TSs carrying SI data that can be processed at a receiving system, e.g., end or user receivers.

Further, digital cable systems according to the background art typically carry program and system information in a separate out-of-band channel to support their proprietary set top boxes (STBs). Thus, it is useful to take advantage of the PSIP data in the input DTV signals to help maintain this out-of-band service information (OOB SI).

### SUMMARY OF THE INVENTION

The present invention is directed to a system and method for processing service information (SI) data from a plurality of input transport streams into at least one output transport stream for a digital broadcasting. In one embodiment, the method includes extracting SI data from the input transport streams, decoding the extracted SI data, mapping the decoded SI data by reconfiguring the SI data for the output transport stream, merging the input transport streams into at least one output data stream based on the mapped Si data, and re-encoding the merged output data stream to generate and output the output transport stream.

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus do not limit the present invention.

FIG. 1 is an example of a general diagram showing the architecture of general PSIP tables.

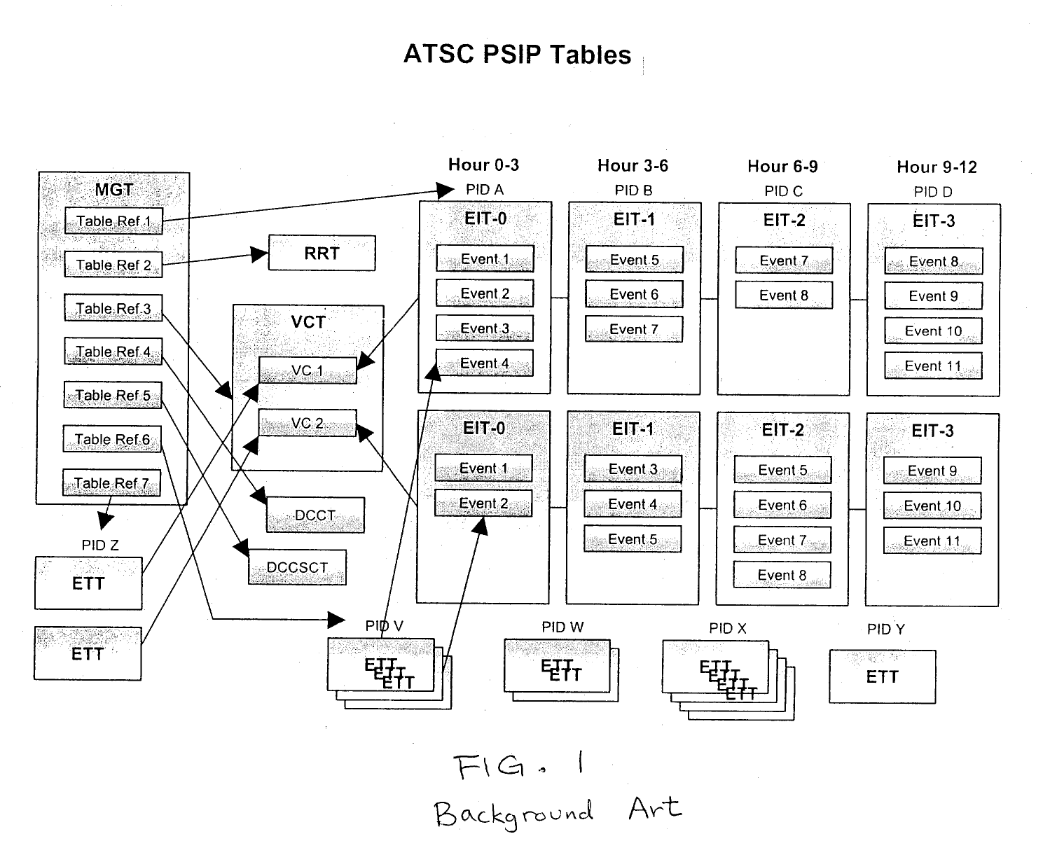

FIG. 2 is a diagram of a system for processing SI data in a digital broadcast environment according to an embodiment of the present invention.

FIG. 3 illustrates a flow diagram of a method for processing SI data at a head-end in a digital broadcast environment according to an embodiment of the present invention.

### DETAILED DESCRIPTION OF THE PREFERRED EMBODIMENTS

Herein, PSI/PSIP data (or PSIP/PSI data) means PSI data and/or PSIP data.

According to an embodiment of the present invention, to merge the PSIP/PSI data from multiple independent input transport streams into one or more output streams, a TS processing system of the present invention is first configured to specify which virtual channels from each input stream are to be included in each output stream, perhaps what changes are to be made to the virtual channel name and/or numbers, which elementary streams of selected virtual channels are to be included in the output stream, how are the PID values of input elementary streams mapped to in the output stream, how many EITs and ETTs are to be included in each output stream, and what PIDs should be used to identify the transport stream packets containing the different EITs and ETTs in each output stream. This can be done through a graphical user interface in the known way and at a metadata processing subsystem of the TS processing system.

The TS processing system according to an embodiment of the present invention can obtain the PSIP and PSI data by several different means. The metadata processing subsystem of the TS processing system may take the full transport stream as an input using a known or standard interface such ASI and SMPTE310. A full transport stream normally contains video, audio, and metadata, and the metadata (e.g., Si data) can be extracted based on the PIDs by the metadata processing subsystem. The TS processing system according to anther embodiment of the present invention may use a multiplexer or similar devices, as a transport stream preprocessor to extract the metadata packets at the multiplexer. The metadata processing subsystem can interface to the multiplexer and obtain metadata packets through a network connection or other known or standard interface.

In all the embodiments discussed herein, the TS processing system is generally implemented at a head-end of a digital broadcast environment. But the TS processing system is implementable as needed at any different stages of digital broadcast.

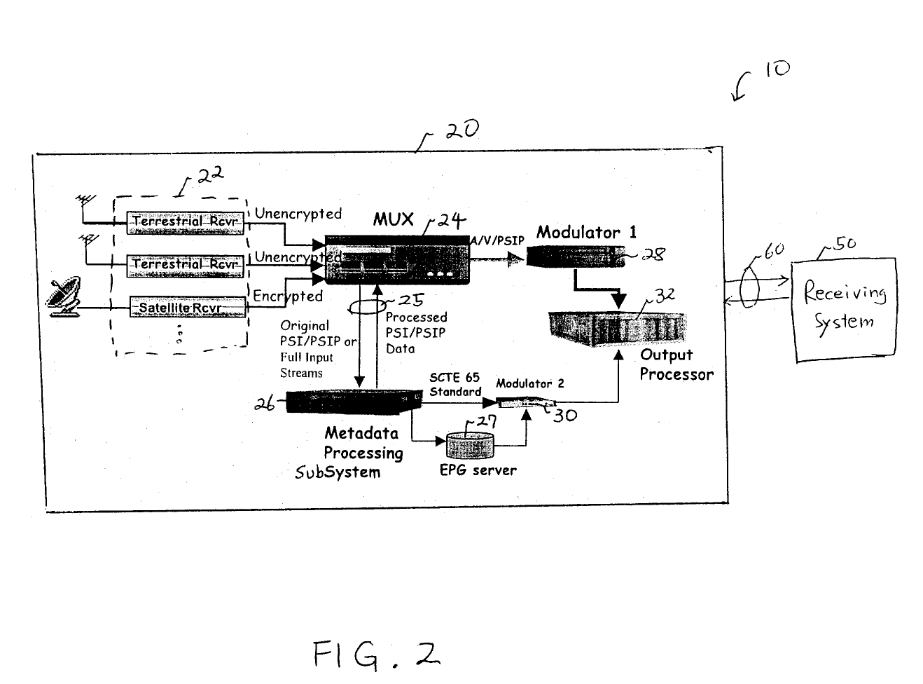

FIG. 2 shows an example of a TS processing system 20 at a cable head-end environment according to one embodiment of the present invention. In this example, the system 20 is part of a DTV broadcast system 10 which includes a receiving system 50 and a network/interface 60 for establishing communication between the TS processing system 20 at the head-end and the receiving system 50 (e.g., at a local station or viewer's TV system).

As shown in FIG. 2, the TS processing system 20 includes one or more head-end receivers 22, a multiplexer 24 (e.g., a traditional MPEG-2 compliant multiplexer or the traditional MPEG-2 compliant multiplexer modified as discussed below), a network/interface 25, a metadata (SI data) processing subsystem 26, first and second modulators 28 and 30, and an output processor 32, all operatively coupled. One skilled in the art would readily appreciate that the modulator 28 is used for audio, video and in-band PSIP data transmission, whereas the second modulator 30 is used for OOB SI transmission according to existing standards such as SCTE 65 standard.

In one embodiment, the TS processing system 20 may need to perform only the in-band PSIP data transmission, in which case the second modulator 30 is not needed. In another embodiment, the TS processing 20 may need to perform only the OOB SI transmission, in which case the first modulator 28 is not needed. In the embodiment shown, both the in-band PSIP transmission and the OOB SI transmission are performed in the TS processing system. The receivers 22, modulators 28 and 30, and the output processor 32 are known.

Multiple transport streams originating from different sources, including off-air terrestrial broadcasts, satellite receivers, and local sources, etc., are received through the receivers 22 at the multiplexer 24. As known, in this example, the terrestrial signals may be unencrypted and the satellite signals may be encrypted. As discussed above, in one embodiment, the traditional MPEG-2 multiplexer 24 may be modified to extract PSI/PSIP data from the receiving input transport streams and output them to the metadata processing subsystem 26 via a network or some known interface 25. In this embodiment, the metadata processing subsystem 26 first asks the multiplexers to extract the base PSIP table packets based on a predefined PID. One of the base tables is MGT, which contains the information of all other PSIP tables, including their PIDs, table IDs, sizes and version numbers. By decoding the MGT, the metadata processing subsystem discovers the PIDs for all PSIP tables. Then it sends control commands to ask the multiplexers to send the remaining PSIP packets with specified PIDs directly from the transport streams.

In another embodiment, the traditional MEPG-2 multiplexer 24 is used to merely output the receiving input transport streams to the metadata processing subsystem 26 which then extracts the PSI/PSIP data from the input transport streams. In still another embodiment, the metadata processing subsystem 26 may directly receive the input transport streams from the head-end receivers 22. In that embodiment, each input transport stream signal may be split into two identical signals using a standard splitter which feeds the traditional MEPG-2 multiplexer 24 and the metadata processing subsystem 26 in parallel. Other variations of the embodiments are also possible.

Depending on the source, some incoming transport streams at the head-end may contain PSIP data while others may not. For example, transport streams received from the off-air terrestrial broadcasts will typically contain PSIP data, while encrypted streams may not include PSIP data. When multiple streams are multiplexed into a single transport stream, the original PSIP data contained in the incoming stream must be translated and reconciled, which is the process carried out by the metadata processing subsystem 26 of the present invention.

The metadata processing subsystem 26 decodes and maps the extracted PSI/PSIP data (e.g., PSIP tables) from the multiple input transport streams, and merges the PSI/PSIP data into one or more output data streams as needed. The metadata processing subsystem 26 then re-encodes the merged PSI/PSIP data into packets to generate one or more output data streams (PSI/PSIP transport streams) and sends the output data stream(s) to the multiplexer 24 and/or the second modulator 30 (depending on whether the in-band and/or output-of-band data transmission is performed). The multiplexer 24 combines the PSI/PSIP stream(s) with the existing elementary streams (video and/or audio streams) and outputs the combined transport streams to the first modulator 28.

The modulators 28 and 30 or the like modulate the received transport streams, which are then further processed by the output processor 32 as needed (e.g., frequency conversion, etc.). Then the output processor 32 transmits the processed output streams carrying video, audio and re-encoded PSI/PSIP data, to the receiving system 50 via the network, interface, cable or some other means. Because the PSI/PSIP data have already been reconfigured to avoid duplicate data such as duplicate PID values, duplicate VC numbers, etc., the receivers at the receiving system 50 can successfully process the received data streams without any problems according to their existing functions.

As discussed above, in accordance with one embodiment of the present invention, the metadata processing subsystem 26 is designed to work together with the traditional MPEG-2 multiplexer 24 (without any modification to the multiplexer 24), thereby allowing the existing MPEG-2 multiplexers responsible for the audio and video streams to process them as known while allowing the subsystem 26 to process the PSI and PSIP data. For the non-encrypted (clear) data streams, once the PSIP data are merged at the metadata processing subsystem 26, the merged PSIP data will be sent back to the multiplexer 24, e.g., through a network connection or other standard interface 25. The multiplexer 24 then re-multiplexes the merged PSIP data with video and audio data, and makes the PSIP data available in-band for the cable-ready receivers.

Because the cable receivers normally use the OOB SI data to tune to the encrypted programs, the presence of in-band PSIP data may be optional for these streams. However, if PSIP data are included in the original encrypted streams, the PSIP-data may be extracted and included in the OOB SI data.

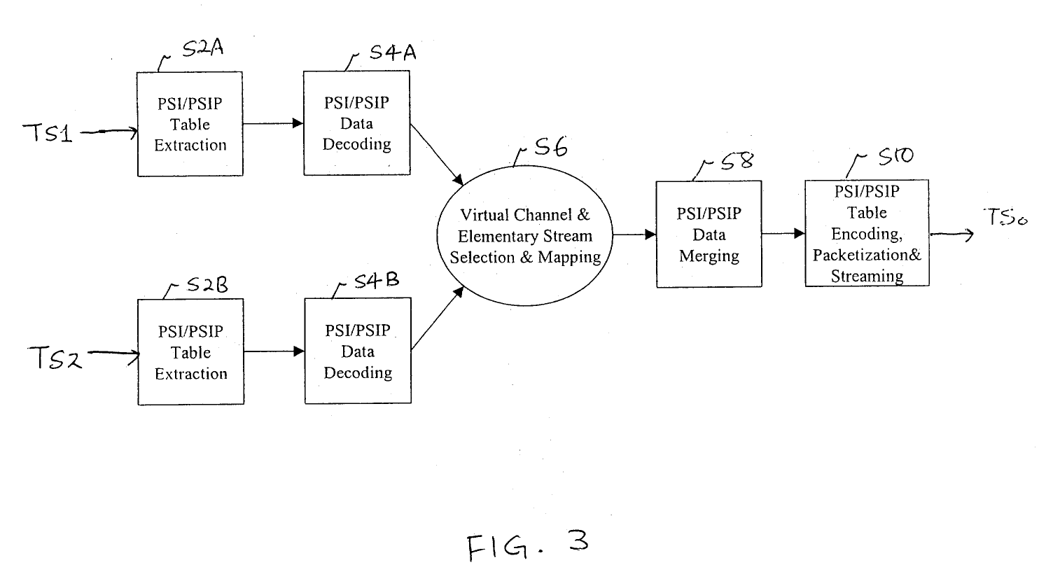

FIG. 3 shows an example of a flow diagram illustrating processing steps of a method for processing SI data accordance with an embodiment of the present invention. These processing steps are implementable in the metadata processing subsystem of the TS processing system 20 of FIG. 2 or other suitable systems, and also implementable by computer software program(s) using known computer programming languages.

In the diagram of FIG. 3, it provides an example of two input transport streams (TS1 and TS2) that are merged to a single output transport stream (TSo) according to the present invention. It should be understood that there could be any number of input transport streams and any number of output transport streams, which may be limited by the physical processing and memory power of the hardware platform. In addition, each input or output may contain multiple virtual channels. Different virtual channels from the same input streams may be mapped to different output streams. Also, a single virtual channel may be mapped to multiple output streams. Obviously, other variations are possible.

Referring to FIGS. 2 and 3, at steps S2A and S2B, PSI/PSIP data (e.g., tables) are extracted from first and second input transport streams TS1 and TS2. To extract the PSI/PSIP data from a transport stream, in one example, the metadata processing subsystem 26 (i.e., the multiplexer 24 or metadata processing subsystem 26) starts by obtaining the MPEG2 transport stream packets with the basic PSIP PID (e.g., 0×1 ffb).

Once the packets with the basic PSIP PID are obtained, the metadata processing system 26 at steps S4A and S4B decodes these packets to get the contents of the tables contained in them. These packets generally include the following tables: MGT, STT, VCT, and RRT, each of which is identified by the table ID for its table type specified in the PSIP standard. Once the MGT is decoded, all other PSIP packets can be identified because the MGT contains the PID information of all other PSIP tables, mainly EITs and ETTs. As soon as the EIT and ETT packets are obtained, the contents of these tables are decoded as much the same way as the base PSIP tables such as MGT. As a result, the contents of the PSI/PSIP tables, such as virtual channels, elementary streams, and program event information, etc., are obtained.

Then the metadata processing subsystem 26 at step S6 maps the obtained PSI/PSIP tables of the input TSs and merges them at step S8 in order to generate a merged PSI/PSIP table(s) for an output stream (or multiple output streams if desired). The mapping generally involves modifying appropriate information to provide a system-compliant output data stream(s), and includes, but is not limited to, modifying virtual channel numbers of the input TSs appropriate to avoid duplicate virtual channel numbers and other duplicate data, changing PIDs for the virtual channels and the elementary streams (video/audio streams) in view of the PID changes to the virtual channels, and modifying optionally the virtual channel names in view of the changes to the virtual channel numbers.

An example of one implementation of the mapping step of S6 is now discussed. In order for multiple input transport streams to be merged into one or more output transport streams for cable carriage, the PSIP data are modified to reflect the characteristics of the new transport stream or streams. Specifically, the following changes are made for individual PSIP tables according to the present invention. In the VCT, the list of virtual channels is decoded in each input stream. The description of each virtual channel is changed to or translated with a new virtual channel number and the frequency and modulation mode of the output transport stream in which it is to be included. If desired, in one example, the virtual channel number can be converted from a two-part, major-minor channel number system in terrestrial broadcast to a one-part number in cable.

Once these translations are made, the virtual channel data for the virtual channels that are to go into each output stream are merged at step S8 together to form a single VCT for the output transport stream. Thus, the result is a set of VCTs, one VCT for each output transport stream, with each VCT containing information about the virtual channels in its output transport stream.

The Event Information Tables (EITs) from different input transport streams are, if applicable, consolidated in the similar fashion at step S8. Because broadcasters have the option to carry different numbers of EITs, the number of EITs may vary in different input transport streams. Also, as indicated above, the number of EITs to be carried in each output transport stream may vary. For each EIT table in a transport stream, either input stream or output stream, multiple table instances may generally exist, one for each virtual channel in the transport stream. Because EIT PIDs are arbitrarily selected by each broadcaster, EIT packets from different input sources may have different or overlapping PIDs. As mentioned previously, in order to process the EITs, the MGT from each input transport stream generally must be decoded first to find all the EIT PIDs. Based on these PIDs, the EIT packets are extracted and decoded. Each EIT instance is then associated to a virtual channel according to the source_id that is used to identify the virtual channel, according to the ATSC PSIP standards or other relevant standards. When virtual channels from multiple input transport streams are merged into an output transport stream, one or more of the source_ids in the VCT and EITs may be modified in order to resolve any conflicts. However, in one embodiment, it is important that the source_id in both VCT and EITs are changed together; otherwise the correct association between the virtual channel and the EIT instance that carries the program information in the virtual channel may be lost. Furthermore, the EITs from multiple input transport streams may also contain conflict event_ids. Thus, one or more event_ids may be modified in order to resolve those conflicts. Because the cable operators can choose the number of EITs to be carried, some EITs in the input transport streams may be filtered out during the merging step.

The cable operators have a choice whether to carry ETTs (Extended Text Tables), and if so how many. If they choose the carriage of ETTs, the ETTs can be processed in a similar way as the EITs. Each ETT is associated to a program event in EIT through event_id. It is also needed that the event_ids in both EIT and ETTs are changed together in order to keep the correct association.

After the changes in EITs and/or ETTs, the MGT for each output transport stream generally is regenerated as part of the encoding step S10 to reflect the presence of the EITs and ETTs, the new PID selections, and the table lengths of all PSIP tables. If the rating region of the input transport stream originator is not the same as that of the cable operator, the Rating Region Table (RRT) may also be changed. Because the contents of the RRT are normally static, it is more convenient to create a new one instead of updating the order one. Similarly, a new System Time Table (STT) can also be easily created to reflect the cable operator's system clock.

In addition, because of changes to the program line-up after transport stream re-multiplexing, as part of the merging step S8 the PAT and PMT are modified or regenerated, using basically in the same method as that used for the VCT. Although MPEG-2 multiplexers can generally handle any PAT and PMT changes, the difference between terrestrial PSIP and cable in-band PSIP may require additional functionalities that do not exist in traditional multiplexers. For example, under certain situations, some descriptors may need to be copied from PSIP tables to the PMTs which would be readily appreciated by one skilled in the art.

Once the new tables are created, the resultant PSIP and PSI tables are then re-encoded and encapsulated into MPEG-2 or other suitable packets and streamed out to the multiplexer 24 and/or the second modulator 30. For instance, in the in-band carriage, the multiplexer 24 receives the re-encoded SI stream(s) from the metadata processing subsystem 26 and in the pass mode, passes the re-encoded SI stream(s) along with the existing elementary stream(s) to the first modulator 28 which in turn modulates the stream(s) as known. In the out-of-band carriage, the re-encoded SI stream is modulated at the second modulator 30 and is carried in a specially-designated channel for carrying only metadata as known. In this case, only special STBs or receivers can access the metadata in the out-of-band carriage.

The resultant streams are further processed at the output processor 32 and sent to the receiving system 50 via the network/interface 60. Since the PSI/PSIP tables have been already reconfigured to eliminate the use of duplicate data such as duplicate PIDs for different data sets, the receivers at the receiving system 50 can effectively process the PSI/PSIP tables without any problems. This provides an effective DTV broadcast system for processing SI data of multiple input transport streams into one or more output transport streams without no or minor modifications to existing elements of the broadcast system.

As discussed above, the cable operators have traditionally sent their EPG data using proprietary formats in the OOB channel. The TS processing system according to an embodiment of the present invention can then generate the OOB SI according to the SCTE standard SCTE 65 or other relevant standards. Although the cable OOB SI carriage delivers information similar to in-band PSIP carriage, the protocol used to format the data is generally different from that of terrestrial or in-band cable PSIP carriage. The cable OOB SI contains several unique tables, including the Network Information table (NIT), Network Text Table (NTT), Short-Form VCT (S-VCT), Long-Form VCT (L-VCT), and Aggregated EITs and ETTs.

In the out-of-band transmission, in accordance with one embodiment of the present invention, both S-VCT and L-VCT are created to include all virtual channels in a cable network. In addition, links between DTV services in input streams and VCs in the output channel map are maintained. To generate the aggregated EITs and aggregated ETTs, a similar process to that of in-band PSIP processing can be used. First, the EITs and ETTs in the input streams are decoded. The decoded tables are updated for any changes in the program source_id. Finally, the aggregated EITs and ETTs are created by combining multiple tables from different sources into single aggregated tables. However, not all OOB SI tables may be created and delivered depending on the profiles selected by the cable operator. DVS-234 defines six profiles for delivery of the service information via the out-of-band channel.

Because the channel lineup and EPG information in DTV streams are constantly being updated, the metadata processing subsystem according to an embodiment of the present invention generally needs to continuously monitor the input streams for any change in PSIP and PSI data. All PSI/PSIP tables contain a version number in the table header. If any changes in table content occur, the version number must be updated. By monitoring the change of version number, the metadata processing subsystem determines whether new tables are received. If any changes are detected, the metadata processing subsystem makes necessary updates in the output(s) using the same steps as illustrated in FIG. 3.

In addition to the in-band PSIP and out-of-band SI generation, the metadata processing subsystem of the present invention performs real-time error monitoring and analysis of incoming streams. A variety of errors may occur in digital broadcast streams. For example, required PSIP and PSI tables may be missing, invalid, or too infrequent. These metadata errors can cause DTV receivers not to tune channels or block unwanted programs properly. They may also result in missing or incorrect on-screen program guide. Other errors may include missing elementary streams, unsynchronized audio and video signal, and timing reference errors. These errors may result in the loss of audio and/or video, or in poor audio and video quality.

To find these errors, the metadata processing system monitors the presence of PSI and PSIP table in the streams and checks the table intervals, syntax, and the consistency of the data across PSIP and PSI tables. In addition, it also checks the presence of the elementary streams. Once any error is found, the metadata processing system logs the error in a computer file and shows the error message through a computer user interface.

In addition, the metadata processing subsystem according to an embodiment of the present invention can provide bit rate estimation and reduction mechanisms in order to meet the bandwidth needs of the cable operators. The method of calculating the bit rate of elementary streams or data streams is well known. Under certain conditions, the broadcasters may want to limit the usage of bandwidth by the PSIP data. The metadata processing subsystem provides a user interface for selecting the number optional PSIP tables, mainly EITs and ETTs, to be included in the outputs transport stream, as well as the frequency of playing out the selected tables.

The metadata processing subsystem according to an embodiment of the present invention can also be linked to the proprietary program guide service to perform real-time-udates of the service information, e.g., using an EPG server 27 in FIG. 2. Conventionally, the cable operators provide EPG information using program lists stored in a database located either locally or in a national service center. The database is usually days or weeks old. When a program, such as a sporting event, runs over time, the EPG information following the overrun program event is out-of-date. But, if the incoming stream contains updated PSIP information according to the present invention, this information could be used to update the cable guide. Depending on the methods used by the cable operator to generate the EGP information, there are multiple possible means to update the EPG service, which are intended to be part of the present invention. For example, one way is for the metadata processing subsystem to access the EPG database and directly update the information in the database if any program schedule has been changed. Another way is for the metadata processing subsystem to provide a standard application programming interface which allows the proprietary EGP service providers to get the updated program schedule from the metadata system.

The present invention can be implemented in various ways using existing hardware and/or software. Any existing computer programming language may be used in this process. For instance, the hardware configuration of the metadata processing subsystem according to an embodiment of the present invention may include, but is not limited to, a computer with a processor, memory for storing table information and other information, input/output ports, and any other known components that would be obvious to one skilled in the art for implementing the present invention. The inventors have successfully implemented the present invention using a standard PC running with Windows NT operating system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for processing service information (SI) data from a plurality of input transport streams into at least one output transport stream for a digital broadcasting, the method comprising:
extracting SI data from the input transport streams;
decoding the extracted SI data; and
mapping the decoded SI data by reconfiguring the SI data for the output transport stream.

2. The method of claim 1, further comprising:
merging the input transport streams into at least one output data stream based on the mapped SI data.

3. The method of claim 2, further comprising:
re-encoding the merged output data stream to generate and output the output transport stream.

4. The method of claim 3, further comprising:
generating out-of-band SI data using the SI data in the output transport stream.

5. The method of claim 1, further comprising:
updating electronic program guide (EPG) data using real-time SI data in the input transport streams.

6. The method of claim 1, further comprising:
monitoring changes in the input transport streams and updating output stream in real-time.

7. The method of claim 1, wherein the mapping step includes:
modifying virtual channel information for each of virtual channels contained in each of the input transport streams to eliminate use of duplicate virtual channel numbers for the input transport streams and to provide unique virtual channel numbers in the output transport streams;
modifying packet identification (PID) information for video and/or audio and/or data streams of the input transport streams based on the modified virtual channel information; and
modifying PID information of program map tables (PMTs) based on the modified virtual channel information.

8. The method of claim 7, wherein the mapping step further includes:
modifying virtual channel names for the virtual channels of the input transport streams for each of the virtual channels of the input transport streams.

9. The method of claim 2, wherein the merging step includes:
consolidating event information tables (EITs) from the input transport streams to avoid duplicate PIDs and source_ids.

10. The method of claim 9, wherein the consolidating step includes:
extracting and decoding EIT packets from the input transport streams;
associating each EIT instance from the decoding step to a virtual channel according to a source_id used to identify the virtual channel;
filtering out any unwanted EITs in the output transport streams; and
modifying the source_id based on the mapped virtual channel information.

11. The method of claim 2, wherein the merging step includes:
consolidating extended text tables (ETTs) from the input transport streams to avoid duplicate PIDs and event_ids.

12. The method of claim 11, wherein the consolidating step includes:
extracting and decoding ETT packets from the input transport streams;
associating each ETT instance from the decoding step to an event in EIT according to an event_id;
filtering out any unwanted ETTs in the output transport streams; and
modifying the event_id according to the event_id in the mapped EIT.

13. The method of claim 2, wherein the merging step further includes:
modifying a master guide table (MGT) for each output transport stream to be generated, to correspond to the consolidated PSIP data including VCT, EITs and ETTs.

14. The method of claim 2, wherein the merging step further includes:
modifying a program association table (PAT) and program map tables (PMTs) based on the mapped-virtual channel and elementary stream PID information.

15. The method of claim 3, wherein the method is implemented in a cable head-end system, and the method further comprises:
controlling at least one MPEG multiplexer of the cable head-end system to pass the output transport stream obtained at the re-encoding step.

16. A system for processing service information (SI) data from a plurality of input transport streams into at least one output transport stream for a digital broadcasting, the system comprising:
a receiver section to receive the plurality of input transport streams;
an extraction section to extract SI data from the input transport streams; and
a metadata processing subsystem to decode the extracted SI data and to map the decoded SI data by reconfiguring the SI data for the output transport stream.

17. The system of claim 16, wherein the metadata processing subsystem merges the SI data of the input transport streams into SI data of at least one output data stream.

18. The system of claim 17, wherein the metadata processing subsystem re-encodes the merged output data stream to generate and output the output transport stream.

19. The system of claim 18, wherein the metadata processing subsystem generates out-of-band SI data using the SI data in the output transport stream.

20. The system of claim 16, further comprising:
means for updating electronic program guide (EPG) data using real-time SI data in the input transport streams.

21. The system of claim 17, further comprising:
means for monitoring changes in the input transport streams and updating output stream in real-time; and
means for monitoring transport stream errors and logging the errors in a computer file and/or showing the error through a computer user interface.

22. The system of claim 17, wherein the metadata processing subsystem modifies virtual channel information for each of virtual channels contained in each of the input transport streams to eliminate use of duplicate virtual channel numbers for the input transport streams, modifies packet identification (PID) information for video and/or audio data streams of the input transport streams based on the modified virtual channel information, and modifies PID information of program map tables based on the modified virtual channel information.

23. The system of claim 22, wherein the metadata processing subsystem modifies virtual channel names for the virtual channels of the input transport streams for each of the virtual channels of the input transport streams.

24. The system of claim 17, wherein the metadata processing subsystem consolidates event information tables (EITs) from the input transport streams to avoid duplicate PIDs.

25. The system of claim 24, wherein the metadata processing subsystem consolidates the EITs by:
extracting and decoding EIT packets from the input transport streams;
associating each EIT instance from the decoding step to a virtual channel according to a source_id used to identify the virtual channel;
filtering out any unwanted EITs in the output transport streams; and
modifying the source_id based on the mapped virtual channel information.

26. The system of claim 17, wherein the metadata processing subsystem consolidates extended text tables (ETTs) from the input transport streams to avoid duplicate PIDs and event_ids.

27. The system of claim 26, wherein the metadata processing subsystem consolidates the ETTs by:
extracting and decoding ETT packets from the input transport streams;
associating each ETT instance from the decoding step to an event in EIT according to an event_id;
filtering out any unwanted ETTs in the output transport streams; and
modifying the event_id according to the event_id in the mapped EIT.

28. The system of claim 17, wherein the metadata processing subsystem modifies a master guide table (MGT) for each output transport stream to be generated, to correspond to the consolidated PSIP data including VCT, EITs and ETTs.

29. The system of claim 17, wherein the metadata processing subsystem modifies a program association table (PAT) and program map tables (PMTs) based on the mapped virtual channel and elementary stream PID information.

30. The system of claim 18, wherein the system is part of a cable head-end and the extraction section includes at least one MPEG multiplexer controlled by the metadata processing subsystem to pass the output transport stream carrying the merged SI data.

31. The system of claim 18, wherein the system is part of a cable head-end and the extraction section is integrated into the metadata processing subsystem.

32. A computer program product embodied on at least one computer-readable medium, for processing service information (SI) data from a plurality of input transport streams into at least one output transport stream for a digital broadcasting, the computer program product comprising computer-executable instructions for:
extracting Si data from the input transport streams;
decoding the extracted SI data; and
mapping the decoded SI data by reconfiguring the Si data for the output transport stream.

33. The computer program product of claim 32, further comprising computer-executable instructions for:
merging the input transport streams into at least one output data stream based on the mapped SI data.

34. The computer program product of claim 33, further comprising computer-executable instructions for:
re-encoding the merged output data stream to generate and output the output transport stream.
